(19) United States
(12) Patent Application Publication
(10) Pub. No.: US 2022/0322694 A1
(43) Pub. Date: Oct. 13, 2022

(54) POLYOL-CONTAINING CHEWING GUM BASES

(71) Applicant: WM. WRIGLEY JR. COMPANY, Chicago, IL (US)

(72) Inventors: David R. PHILLIPS, Downers Grove, IL (US); Mandy TAYLOR, Chicago, IL (US); Michael CATIZONE, Plainfield, IL (US)

(21) Appl. No.: 17/627,778

(22) PCT Filed: Jul. 24, 2020
(86) PCT No.: PCT/US2020/043490

§ 371 Date: Jan. 17, 2022

Related U.S. Application Data
(60) Provisional application No. 62/879,128, filed on Jul. 26, 2019.

(51) Int. Cl. A23G 4/08; A23G 4/06

(52) U.S. Cl. CPC A23G 4/08; A23G 4/064; A23V 2002/00

(57) ABSTRACT

The present disclosure is directed to chewing gum bases, where mineral filler in the gum base formulation has been replaced with a polyol. The chewing gum bases of the present disclosure are thus essentially free of mineral filler, and contain a polyol, such as mannitol. Also disclosed are processes for producing the chewing gum bases. The processes of the present disclosure utilize polyol as a replacement for mineral fillers during various production stages. Confectionery products, such as chewing gums, that comprise the chewing gum bases are also disclosed.

### BACKGROUND OF THE DISCLOSURE

The present disclosure is directed to chewing gum bases, where mineral filler in the gum base formulation has been replaced with a polyol. The chewing gum bases of the present disclosure are thus essentially free of mineral filler, and contain a polyol, such as mannitol. Also disclosed are processes for producing the chewing gum bases. The processes of the present disclosure utilize polyol as a replacement for mineral fillers during various production stages. Confectionery products, such as chewing gums, that comprise the chewing gum bases are also disclosed.

Mineral fillers, such as talc and calcium carbonate, are commonly included in chewing gum bases as bulk fillers. Mineral fillers may also be utilized during the formation of chewing gum bases. For example, such fillers may be used at multiple stages during the gum base production process, such as during elastomer grinding, base pellet dusting, and gum rolling, among others. Although it is possible to produce chewing gum bases without the use of mineral fillers, the resulting gum bases may be lower in viscosity, have a lower density, and have increased tack, which could result in added challenges during shipping and handling of the gum bases. Costly changes in established gum base production processes may also be necessary in order to produce chewing gum bases that are free of mineral filler.

It would thus be desirable to produce chewing gum bases that do not contain mineral filler, but that closely maintain the function and benefit associated with mineral filler, with minimal impact to the properties of the resulting gum base or the process used to produce the gum base.

### SUMMARY OF THE DISCLOSURE

The present disclosure is directed to chewing gum bases, where mineral filler in the gum base formulation has been replaced with a polyol. The chewing gum bases of the present disclosure are thus essentially free of mineral filler, and contain a polyol, such as mannitol. Also disclosed are processes for producing the chewing gum bases. The processes of the present disclosure utilize polyol as a replacement for mineral fillers during various production stages. Confectionery products, such as chewing gums, that comprise the chewing gum bases are also disclosed.

In one aspect, the present disclosure is directed to a chewing gum base comprising a polyol, wherein the chewing gum base is essentially free of mineral filler. In one embodiment, the polyol is mannitol.

In another aspect, the present disclosure is directed to a process for grinding an elastomer, the process comprising: combining an elastomer with a polyol to form an elastomer blend, and grinding the elastomer blend, wherein the elastomer blend is essentially free of mineral filler. In one embodiment, the polyol is mannitol.

In another aspect, the present disclosure is directed to a process for preparing a chewing gum base, the process comprising mixing an elastomer and a polyol, wherein the chewing gum base is essentially free of mineral filler. In one embodiment, the polyol is mannitol. In another embodiment, the elastomer comprises a ground elastomer, and the process further comprises combining an elastomer with a polyol to form an elastomer blend and grinding the elastomer blend to form the ground elastomer, wherein the elastomer blend is essentially free of mineral filler. In another embodiment, the process further comprises dusting the chewing gum base with a polyol.

In another aspect, the present disclosure is directed to a process for producing a dusted chewing gum base, the process comprising dusting a chewing gum base with a polyol. In one embodiment, the polyol is mannitol. In another embodiment, the dusted chewing gum base is essentially free of mineral filler.

Other aspects of the present disclosure are described elsewhere herein.

### BRIEF DESCRIPTION OF THE DRAWINGS

FIGS. 1A and 1B are pictures of blends of butyl rubber and a dusting powder following grinding, and 48 hours after stress testing for rubber blocking, as described in Example 1. 1A: control blend containing butyl rubber and talc; 1B: experimental blend containing butyl rubber and mannitol.

FIGS. 2A, 2B, 3A, and 3B are pictures of a soft bubble gum base dusted with either 2% talc (control, 2A, 2B) or 4% mannitol (experimental, 3A, 3B) after an accelerated base stress blocking test was performed, as described in Example 3. FIG. 2A depicts the control gum base sample (dusted with 2% talc) during the accelerated base stress blocking test. FIG. 2B depicts the control gum base sample after completion of the accelerated base stress blocking test. FIG. 3A depicts the experimental gum base sample (dusted with 4% mannitol) during the accelerated base stress blocking test. FIG. 3B depicts the experimental gum base sample after completion of the accelerated base stress blocking test.

### DETAILED DESCRIPTION OF THE DISCLOSURE

The present disclosure is directed to chewing gum bases, where mineral filler in the gum base formulation has been replaced with a polyol. The chewing gum bases of the present disclosure are thus essentially free of mineral filler, and contain a polyol, such as mannitol. Also disclosed are processes for producing the chewing gum bases. The processes of the present disclosure utilize polyol as a replacement for mineral fillers during various production stages. Confectionery products, such as chewing gums, that comprise the chewing gum bases are also disclosed.

### Chewing Gum Base

Chewing gum generally comprises a water-soluble portion and a water insoluble portion. The water insoluble portion is referred to as the gum base.

It has now been discovered that chewing gum bases can be formulated that are essentially free of mineral filler, but that still closely maintain the function and benefit associated with the inclusion of mineral fillers in chewing gum bases. In particular, it has been discovered that replacing mineral fillers in chewing gum bases with a polyol, such as mannitol, results in a chewing gum base that has similar product performance to that of traditional chewing gum bases containing mineral fillers.

The present disclosure thus provides a chewing gum base that is essentially free of mineral filler, and that comprises a polyol. Also provided are chewing gums prepared from the chewing gum bases, and processes for producing the chewing gum bases.

As used herein, the term “essentially free of mineral filler” means no mineral fillers were affirmatively added to the chewing gum base during production, and no mineral fillers were affirmatively used at any stage of gum base processing. The chewing gum bases of the present disclosure that are essentially free of mineral filler will thus typically contain mineral fillers in an amount of about 0% to about 5% by weight of the chewing gum base, including in amounts of less than 5%, less than 4%, less than 3%, less than 2%, less than 1%, less than 0.5%, less than 0.2%, and less than 0.1% by weight of the chewing gum base. Preferably, the chewing gum base is free of mineral filler (i.e., contains mineral fillers in an amount of 0% by weight).

As used herein, the term “mineral filler” includes, but is not limited to, carbonate or precipitated carbonate types, such as magnesium and calcium carbonate, ground limestone, silicate types such as magnesium and aluminum silicate, clay alumina, talc, titanium dioxide, mono-, di- and tricalcium phosphate, calcium sulfate, kaolin clay, and combinations thereof. In one embodiment, the mineral filler is selected from the group consisting of talc, calcium carbonate, and combinations thereof.

Polyols are used herein to replace mineral fillers in the chewing gum bases of the present disclosure. Any suitable polyol known in the art may be used in the gum bases of the present disclosure. Examples of suitable polyols include, but are not limited to, mannitol, isomalt, erythritol, xylitol, maltitol, isomaltulose, sorbitol, allulose, and combinations thereof. In one embodiment, the polyol is mannitol. Mannitol is particularly useful as a replacement for mineral fillers in chewing gum bases, because it has a melting point (e.g., around 165-169° C.) that is above the typical temperatures used during chewing gum base processing and manufacture. Mannitol further has a low solubility and is the least hygroscopic of the polyols.

In another embodiment, non-mineral fillers can be used in addition to, or as an alternative to polyols, in the chewing gum bases and processes of the present disclosure. Thus, in one embodiment, the present disclosure is directed to a chewing gum base that is essentially free of mineral filler, and that comprises a non-mineral filler. In such an embodiment, the chewing gum base may optionally further include a polyol, as set forth herein. Non-mineral fillers may also be used in addition to, or as an alternative to polyols in any of the processes for producing chewing gum base, elastomer grinding, and/or gum base dusting that are described herein. Suitable amounts of non-mineral filler in the chewing gum bases or processes of the present disclosure are the same as those set forth herein for polyols. Examples of suitable non-mineral fillers include, but are not limited to, zein, oat fiber, gluten, casein, cellulose fibers, and combinations thereof.

The gum bases of the present disclosure will typically include polyol in an amount of from about 0.5% to about 25% by weight of the gum base, and more typically in an amount of from about 5% to about 20% by weight of the gum base. Unless otherwise indicated, the amount of polyol present in the gum bases of the present disclosure includes not only polyol compounded into the gum base formula, but also polyol present in the gum base resulting from the use of the polyol during one or more step of gum base production (e.g., elastomer grinding, gum base dusting, etc.). It should be understood that the amount of polyol present in the gum base may vary depending on the degree to which polyol is used during production of the gum base. For example, if the polyol is only used during elastomer grinding and is not otherwise compounded into the gum base or dusted onto the gum base, polyol will be present in the gum base in amounts at the lower end of this range. If the polyol is used during multiple stages of gum base production (e.g., during elastomer grinding, compounded into the gum base, and gum base dusting), polyol will be present in the gum base in higher amounts.

In addition to the polyol, the chewing gum bases of the present disclosure may contain any combination of elastomers, elastomer plasticizers, resins, emulsifiers, waxes, and other optional ingredients such as antioxidants.

Elastomers provide the rubbery, cohesive nature to the gum which varies depending on this ingredient's chemical structure and how it is compounded with other ingredients. Elastomers suitable for use in the chewing gum base and chewing gum of the present disclosure include, but are not limited to, butadiene-styrene copolymers (SBR), isobutylene-isoprene copolymers (butyl rubber), polybutadiene, low or medium molecular weight polyisobutylene, and vinyl polymeric elastomers (polyvinyl acetate, polyethylene, vinyl acetate/vinyl laurate, vinyl acetate/vinyl stearate, ethylene/vinyl acetate) and combinations thereof. Natural elastomers which may be similarly incorporated into the gum bases of the present disclosure include jelutong, lechi caspi, perillo, sorva, massaranduba balata, massaranduba chocolate, nispero, rosindinha, chicle, gutta hang kang, hevea, TKS, guayule, and combinations thereof. Elastomers may be present in the gum base at levels of about 1 to about 30%, or about 2 to about 25% or about 5 to about 20% by weight of the gum base.

The gum base of the present disclosure may further comprise an elastomer plasticizer (i.e., elastomer solvent), which serves to vary the firmness of the gum base, and to soften the elastomer and allow it to be blended with other gum base components. Plasticizers used in the gum base of the present disclosure may include triacetin, medium chain triglyceride, mono-, di- and triglycerides of fatty acids, terpene resins derived from alpha-pinene, beta-pinene or d-limonene, triglycerides of non-hydrogenated, partially hydrogenated and fully hydrogenated cottonseed oil, soybean oil, palm oil, palm kernel oil, coconut oil, safflower oil, tallow oil, cocoa butter, unsaturated oils that contain, as one or more of their constituent groups, fatty acids of carbon chain length of from 6 to 18, monoglycerides, diglycerides, acetylated monoglycerides, distilled mono-, and di-glycerides and lecithin may, from their manufacturing processing, contain triglyceride levels less than 2 percent by weight. Mono- and diglycerides maybe considered as being of the same family as fats. In one embodiment, the plasticizers are selected from the group consisting of triacetin, acetylated mono-, di- and triglycerides of short chain fatty acids, acetlyated mono-, di- and triglycerides of medium chain fatty acids, acetylated monoglycerides of long chain fatty acids, methyl ester of rosin, low molecular weight PVAc, and combinations thereof.

The elastomer plasticizers used may be of one type or of combinations of more than one. Typically, the ratios of one to the other are dependent on each respective softening point, on each effect on flavor release, and on each respective degree of tack they cause to the gum. In one embodiment, the elastomer plasticizers of the present disclosure are terpene resins. Elastomer plasticizers may be included at levels of about 1 to about 50%, or about 3 to about 40%, or about 5 to about 35% by weight of the gum base.

Emulsifiers, which also sometimes have plasticizing properties, used in gum bases of the present disclosure may be selected from the group consisting of: glycerol mono and distearate, lecithin, mono and di-glycerides of fatty acids, triacetin, acetylated monoglyceride, polyglycerol esters, glycerol triacetate and carbohydrate polyesters, and combinations thereof.

The gum bases of the present disclosure may further contain waxes, or alternately, may be essentially free of waxes. Waxes aid in the solidification of gum bases and improving the shelf-life and texture. Wax crystal also improves the release of flavor. The smaller crystal size allows slower release of flavor since there is more hindrance of the flavor's escape from this wax versus a wax having larger crystal sizes.

Synthetic waxes are produced by means atypical of petroleum wax production and thus are not considered petroleum wax. These synthetic waxes may be used in accordance with the present disclosure and may be included optionally in the gum base and gum.

The synthetic waxes may include waxes containing branched alkanes and copolymerized with monomers such as, but not limited to, polypropylene and polyethylene and Fischer-Tropsch type waxes. Polyethylene wax is not in the same category as polyethylene, a polymer of ethylene monomers. Rather, polyethylene wax is a synthetic wax containing alkane units of varying lengths having attached thereto ethylene monomers.

In another embodiment, the gum bases of the present disclosure are wax-free. In these embodiments, wax is omitted and may be compensated for by using increased levels of fats and oils as is known in the art.

Other optional ingredients, such as antioxidants, may also be used in the gum base. Antioxidants prolong shelf-life and storage of gum base, finished gum or their respective components, including fats and flavor oils. Antioxidants suitable for use in gum base or gum of the present disclosure include butylated hydroxyanisole (BHA), butylated hydroxytoluene (BHT), beta-carotenes, tocopherols, acidulants such as vitamin C, propyl gallate, and other synthetic and natural types, or combinations thereof. Preferably, the antioxidants used in the gum base are butylated hydroxyanisole (BHA), butylated hydroxytoluene (BHT), tocopherols, or combinations thereof.

Flavorants and colorants impart characteristics or remove or mask undesired characteristics and may optionally be included in the gum base of the present disclosure. Colorants may typically include FD&C type lakes, plant extracts, fruit and vegetable extracts, and titanium dioxide. Flavorants may typically include cocoa powder, heat-modified amino acids and other vegetable extracts. Other examples of suitable flavorants and colorants include those described herein as optional additives to a chewing gum of the present disclosure.

Selection of various components in chewing gum bases or chewing gum formulations of this disclosure typically are dictated by factors, including for example the desired properties (e.g., physical (mouthfeel), taste, odor, and the like) and/or applicable regulatory requirements (e.g., in order to have a food grade product, food grade components, such as food grade approved oils like vegetable oil, may be used). Optional gum base additives, such as antioxidants, colors, flavors, and/or sweeteners, if used in the gum base, are typically employed at levels of about 1% or less by weight of the gum base.

### Confectionery Products

Also disclosed herein are confectionery products comprising a chewing gum base of the present disclosure. In one particular embodiment, the chewing gum base of the present disclosure may be used to form a chewing gum. The chewing gum base of the present disclosure may constitute from about 5 to about 95% by weight of a chewing gum. More typically, the chewing gum base may constitute from about 10 to about 50% by weight of the chewing gum, or from about 20% to about 35% by weight of the chewing gum.

In addition to a water-insoluble gum base portion, a typical chewing gum composition includes a water-soluble bulk portion (or bulking agent) and one or more flavoring agents. The water-soluble portion can include high intensity sweeteners, binders, flavoring agents (also referred to herein as flavorants or flavors) (which may be water insoluble), water-soluble softeners, gum emulsifiers, colorants, acidulants, fillers, antioxidants, and other components that provide desired attributes.

Water-soluble softeners, which may also be known as water-soluble plasticizers and plasticizing agents, generally constitute between approximately 0.5 to about 25% by weight of the chewing gum. Water-soluble softeners may include glycerin, lecithin, and combinations thereof. Aqueous sweetener solutions such as those containing sorbitol, hydrogenated starch hydrolysates (HSH), corn syrup and combinations thereof, may also be used as softeners and binding agents (binders) in chewing gum.

A bulking agent or bulk sweetener may be useful in chewing gums of this disclosure to provide sweetness, bulk and texture to the product. Typical bulking agents include sugars, sugar alcohols, and combinations thereof. Bulking agents typically constitute from about 5 to about 95% by weight of the chewing gum, more typically from about 20 to about 80% by weight and, still more typically, from about 30 to about 70% by weight of the gum. Sugar bulking agents generally include saccharide containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol, isomaltulose, hydrogenated starch hydrolysates, allulose, and combinations thereof are substituted for sugar bulking agents. Sugar alcohols are sometimes referred to as polyols or alditols. Combinations of sugar and sugarless bulking agents may also be used.

In addition to the above bulk sweeteners, chewing gums typically comprise a binder/softener in the form of a syrup or high-solids solution of sugars and/or sugar alcohols. In the case of sugar gums, corn syrups and other dextrose syrups (which contain dextrose and significant amounts higher saccharides) are most commonly employed. These include syrups of various DE levels including high-maltose syrups and high fructose syrups. In the case of sugarless products, solutions of sugar alcohols including sorbitol solutions and hydrogenated starch hydrolysate syrups are commonly used. Also useful are syrups such as those disclosed in U.S. Pat. No. 5,651,936 and US 2004/234648, which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed. In the case of syrups and other aqueous solutions, it is generally desirable to use the minimum practical level of water in the solution to the minimum necessary to keep the solution free-flowing at acceptable handling temperatures. The usage level of such syrups and solutions should be adjusted to limit total moisture in the gum to less than 3 wt. %, preferably less than 2 wt. % and most preferably less than 1 wt. %.

High intensity artificial sweeteners can also be used in combination with the above-described sweeteners. Preferred sweeteners include, but are not limited to sucralose, aspartame, salts of acesulfame, alitame, neotame, saccharin and its salts, cyclamic acid and its salts, glycyrrhizin, stevia and stevia compounds such as rebaudioside A, dihydrochalcones, thaumatin, monellin, lo han guo and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8% by weight. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low-calorie gum is desired, a low caloric bulking agent can be used. Examples of low caloric bulking agents include: polydextrose; Raftilose, Raftilin; fructooligosaccharides (NutraFlora); Palatinose oligosaccharide; Guar Gum Hydrolysate (Sun Fiber); or indigestible dextrin (Fibersol). However, other low-calorie bulking agents can be used. In addition, the caloric content of a chewing gum can be reduced by increasing the relative level of gum base while reducing the level of caloric sweeteners in the product. This can be done with or without an accompanying decrease in piece weight.

Flavorants and colorants impart characteristics or remove or mask undesired characteristics. For example, flavoring agents can be employed to impart a characteristic aroma and taste sensation to confectionery products, such as chewing gums. A variety of flavoring agents can be used in the chewing gums of the present disclosure. The flavoring agent can be used in amounts of approximately 0.1 to about 15 weight percent of the gum, and preferably, about 0.2 to about 5 wt % of the gum. Most flavoring agents are water-insoluble liquids but water-soluble liquids and solids are also known. These flavoring agents may be natural or artificial (synthetic) in origin. Often natural and artificial flavors are combined. It is also common to blend different flavors together in pleasing combinations. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

Although the range of flavors usable in chewing gums is nearly limitless, they commonly fall into several broad categories. For example, in one particular embodiment, the confectionery product is a fruit-based chewing gum, which includes one or more fruit flavor (i.e., flavoring agent). Suitable fruit flavors include, but are not limited to, lemon, orange, lime, grapefruit, tangerine, strawberry, apple, cherry, raspberry, blackberry, blueberry, banana, pineapple, cantaloupe, muskmelon, watermelon, grape, currant, mango, kiwi and many others as well as combinations.

In another embodiment, the confectionery product is a mint-based chewing gum, which includes one or more mint flavor (i.e., flavoring agent). Suitable mint flavors include, but are not limited to, spearmint, peppermint, wintergreen, basil, corn mint, menthol and others and mixtures thereof.

In another embodiment, the confectionery product is a spice-based chewing gum that includes one or more spice flavor (i.e., flavoring agent). Suitable spice flavors include, but are not limited to, cinnamon, vanilla, clove, chocolate, nutmeg, coffee, licorice, eucalyptus, ginger, cardamom and many others.

In other embodiments, the chewing gums of the present disclosure may include herbal and/or savory flavors such as popcorn, chili, corn chip and the like. In still other embodiments, the chewing gum of the present disclosure includes combinations of different types of flavors. For example, the chewing gum may include one or more flavoring agent selected from the group consisting of fruit flavors, mint flavors, spice flavors, herbal flavors, savory flavors, and combinations thereof.

Sensate components which impart a perceived tingling or thermal response while chewing, such as a cooling or heating effect, also may be optionally included in the chewing gums of the present disclosure. Generally, sensates may be any compounds that cause a cooling, heating, warming, tingling or numbing, for example, to the mouth or skin. Cooling agents are trigeminal stimulants that impart a cool sensation to the mouth, throat and nasal passages. The most widely known cooling agent is menthol, although this is often considered a flavor due to its aroma properties and the fact that it is a natural component of peppermint oil. More often, the term cooling agent refers to other natural or synthetic chemicals used to impart a cooling sensation with minimal aroma. Commonly employed cooling agents include ethyl p-menthane carboxamide and other N-substituted p-menthane carboxamides, N,2,3-trimethyl-2-isopropyl-butanamide and other acyclic carboxamides, menthyl glutarate (Flavor Extract Manufacturing Association (FEMA 4006)), 3-1-menthoxypropane-1,2-diol, isopulegol, menthyl succinate, menthol propylene glycol carbonate, menthol ethylene glycol carbonate, menthyl lactate, menthyl glutarate, menthone glyceryl ketal, p-menthane-1,8-diol, menthol glyceryl ether, N-tertbutyl-p-menthane-3-carboxamide, p-menthane-3-carboxylic acid glycerol ester, methyl-2-isopryl-bicyclo (2.2.1), heptane-2-carboxamide, menthol methyl ether and others and combinations thereof.

Cooling agents may be employed to enhance the cool taste of mint flavors or to add coolness to fruit and spice flavors. Cooling agents also provide the perception of breath freshening, which is the basis of the marketing of many chewing gums and confections.

Trigeminal stimulants other than cooling agents may be employed in the chewing gums of the present disclosure. These include warming agents such as capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether and unsaturated amides and tingling agents such as Jambu extract, vanillyl alkyl ethers such as vanillyl n-butyl ether, spilanthol, Echinacea extract and Northern Prickly Ash extract. Some of these components are also used as flavoring agents.

In one embodiment, the sensate may include cyclic and acyclic carboxamides, menthol derivatives, and capsaicin among others. Acidulants may be included to impart tartness.

It is common to co-dry and encapsulate flavors and/or sensates with various carriers and/or diluents. A chewing gum composition made with the chewing gum base of the present disclosure may thus also have spray dried flavor as a partial or complete replacement of liquid flavor. For example, spray-dried flavors using gum Arabic, starch, cyclodextrin or other carriers are often used in chewing gum for protection, controlled release, control of product texture and easier handling as well as other reasons. When flavors are in such forms, it will often be necessary to increase the usage level to compensate for the presence of the carriers or diluents. The loading of the spray dried flavor used in the present invention can be approximately 20% active. The amount of spray dried flavor may be used up to about 2% by weight of the chewing gum composition. In some embodiments, spray dried flavor is used in amounts ranging from about 0.2% to about 2% by weight of the chewing gum composition. Even more preferably, spray dried flavor is used at about 1% by weight of the chewing gum composition.

Other optional ingredients such as colors, emulsifiers and pharmaceutical agents, active agents, antimicrobials, tooth whitening agents, medicaments, breath freshening agents, wellness agents, weight loss agents, and combinations thereof may also be added to the chewing gum. Colorants may typically include FD&C type lakes, plant extracts, fruit and vegetable extracts and titanium dioxide.

In one embodiment, the confectionery product is a pharmaceutical-based chewing gum that includes one or more oral or dental health care agent and/or a biologically active agent. For example, in one embodiment, the chewing gums of the present disclosure may further include optional ingredients such as dental health actives such as minerals, nutritional supplements such as vitamins, health promoting actives such as antioxidants for example resveratrol, stimulants such as caffeine, medicinal compounds such as antimicrobials, and other such additives. These active agents may be added neat to the gum mass or encapsulated using known means to prolong release and/or prevent degradation. The actives may be added to coatings, rolling compounds and liquid or powder fillings where such are present.

More particularly, chewing gum generally conveys oral care benefits. In addition to mechanical cleaning of the teeth provided by the chewing action, saliva stimulated by chewing, flavor and taste from the product conveys additional beneficial properties in reducing bad breath, neutralizing acid, and the like. Saliva also contains beneficial polypeptides and other components which may improve the oral environment. These include: antimicrobial proteins, such as lysozyme, lactoferrin, peroxidases, and histatins; inhibitors of spontaneous crystallization, such as statherin.

The chewing gums of the present disclosure can provide these benefits along with the benefits disclosed herein and may also be used as vehicles for the delivery of specialized oral care agents. These may include antimicrobial compounds such as Cetylpyridinium Chloride (CPC), triclosan and chlorhexidine; anti-caries agents such as calcium and phosphate ions, plaque removal agents such as abrasives, surfactants and compound/ingredients; plaque neutralization agents such as ammonium salts, urea and other amines; anti-tartar/calculus agents such as soluble pyrophosphates salts; anti halitosis agents such as parsley oil and copper or zinc salts of gluconic acid, lactic acid, acetic acid or citric acid, and whitening agents such as peroxides; agents that may provide either local or systemic anti-inflammatory effects to limit gingivitis, such as COX-2 inhibitors; agents that may reduce dentinal hypersensitivity, such as potassium salts to inhibit nerve cell transmission, and calcium phosphate salts to block the dentinal tubules.

Certain flavors such as peppermint, methyl salicylate, thymol, eucalyptol, cinnamic aldehyde and clove oil (eugenol) may have antimicrobial properties which benefit the oral cavity. These flavors may be present primarily for flavoring purposes or may be added specifically for their antimicrobial properties.

Certain mineral agents may contribute to dental health by combating demineralization and enhancing remineralization of teeth. Such ingredients include fluoride salts, dental abrasives and combinations thereof.

The chewing gums of the present disclosure may also be used to deliver biologically active agents to the chewer. Biologically active agents include vitamins, minerals, anti-oxidants, nutritional supplements, dietary supplements, functional food ingredients (e.g., probiotics, prebiotics, lycopene, phytosterols, stanol/sterol esters, omega-3 fatty acids, adenosine, lutein, zeaxanthin, grape seed extract, Ginkgo biloba, isothiocyanates and the like), OTC and prescription pharmaceuticals, vaccines, and nutritional supplements.

It may be desirable to take certain steps to increase or decrease the rate of the release of the agent or to ensure that at least a minimum quantity is released. Such measures as encapsulation, isolation of the active, measures to increase or decrease interaction with the water-insoluble portion of the gum and enteric coating of actives may be employed to that end.

### Preparation of Gum Base

As discussed herein, mineral fillers are often used during the formation of chewing gum bases. For example, such fillers may be used at multiple stages during the gum base manufacturing process, such as during elastomer grinding, elastomer compounding, base pellet dusting, and gum rolling, among others. It has now been discovered that the mineral filler used during one or all of these stages of gum base production can be eliminated and replaced with one or more polyol. The resulting processes produce gum bases that are essentially free of mineral filler, but that still closely maintain the function and benefit associated with the inclusion of mineral fillers in chewing gum bases.

Thus, in another aspect, the present disclosure is directed to processes for preparing the gum bases of the present disclosure, wherein the processes proceed without the use of mineral fillers.

### Elastomer Grinding

Mineral fillers, and in particular talc and calcium carbonate, are commonly used in the process of grinding certain elastomers, such as butyl rubber, butadiene-styrene copolymers (SBR), and polyisobutylene (PIB), prior to gum base formation. For grinding, the mineral fillers are typically used at concentrations of about 3 to about 10% by weight of the elastomer. Elastomer grinding may improve the efficiency of base mixing by reducing the mixing times of the batch base and enabling the use of extruders in conjunction with calibrated feeders. The mineral fillers are used as a processing aid in the grinding process and help prevent the ground elastomer from blocking during feeding and conveying to the mixers or extruders. In the processes of the present disclosure, the mineral fillers are replaced by one or more polyol during the grinding process.

Thus, in one aspect, the present disclosure is directed to a process for grinding an elastomer, the process comprising combining an elastomer with a polyol to form an elastomer blend, and grinding the elastomer blend, wherein the elastomer blend is essentially free of mineral filler. In one embodiment, the elastomer blend is free of mineral filler. Suitable polyols for use in this process include any of those polyols set forth herein for inclusion in the gum base, for example, mannitol, isomalt, erythritol, xylitol, maltitol, isomaltulose, sorbitol, allulose, and combinations thereof. In one particular embodiment, the polyol is mannitol. In one embodiment, the elastomer to be ground is selected from the group consisting of isobutylene-isoprene copolymers (butyl rubber), butadiene-styrene copolymers (SBR), polyisobutylene (PIB), and combinations thereof. In one particular embodiment, the elastomer to be ground is butyl rubber.

The polyol typically will be present in the elastomer blend in an amount of from about 3 to about 10% by weight of the elastomer blend. In one embodiment, the polyol is present in the elastomer blend in an amount of about 3% by weight of the elastomer blend.

The grinding may be accomplished using any suitable grinder known in the art.

### Compounding

Gum bases are typically prepared by adding an amount of the elastomer, polyol, and any plasticizer to a heated (50-240° F.) sigma blade mixer with a front to rear speed ratio of about 1:1 to about 2:1, the higher ratio typically being used for chewing gum base which requires more rigorous compounding of its elastomers. In one embodiment, the elastomer is ground according to the process described herein prior to mixing with the plasticizer. In another embodiment, elastomer may comprise a ground elastomer, an unground elastomer, or combinations thereof. The unground elastomer may be any elastomer that has not been previously ground.

Compounding typically begins to be effective once the ingredients have massed together and become homogenous. Anywhere from 15 minutes to 90 minutes may be the length of compounding time. Preferably, the time of compounding is from 20 minutes to about 60 minutes. The amount of added plasticizer depends on the level of elastomer present. If too much elastomer plasticizer is added, the initial mass becomes over plasticized and not homogeneous.

Continuous processes using mixing extruders may also be used to prepare the gum base. After the initial ingredients have massed homogeneously and been compounded for the time desired, the balances of the base ingredients are added in a sequential manner until a completely homogeneous molten mass is attained. Typically, any remainder of elastomer and plasticizer are added after the initial compounding time. The optional waxes and the oils are typically added after the elastomer and plasticizers and during the next 60 minutes. Then the mass is allowed to become homogeneous before discharging.

U.S. Pat. No. 6,238,710, herein incorporated by reference, claims a method for continuous chewing gum base manufacturing. The method entails compounding all ingredients in a single extruder. U.S. Pat. No. 6,086,925 discloses the manufacture of chewing gum base by adding a hard elastomer, a filler and a lubricating agent to a continuous mixer. U.S. Pat. No. 5,419,919 discloses continuous gum base manufacture using a paddle mixer by selectively feeding different ingredients at different locations on the mixer. Yet another U.S. Pat. No. 5,397,580 discloses continuous gum base manufacture wherein two continuous mixers are arranged in series and the blend from the first continuous mixer is continuously added to the second continuous mixer.

Typical base batch processing times may vary from about one to about three hours, preferably from about 1.5 to 2.5 hours, depending on the formulation. The final mass temperature when discharged may be between 50° C. and 130° C. and preferably between 70° and 120°. The completed molten mass is emptied from the mixing kettle into coated or lined pans, extruded or cast into any desirable shape and allowed to cool and solidify. Those skilled in the art will recognize that many variations of the above described procedure may be followed.

In the alternative continuous process, ingredients are added continuously at various points along the length of the extruder. In this case, the transit time through the extruder would be substantially less than an hour.

As discussed herein, in the gum bases of the present disclosure, mineral fillers are replaced with one or more of polyol, resulting in a gum base that comprises a polyol, but that is essentially free of mineral filler. Thus, in another aspect, the present disclosure is directed to a process for preparing a chewing gum base of the present disclosure. The process comprises mixing an elastomer and a polyol, wherein the chewing gum base is essentially free of mineral filler. In one embodiment, the chewing gum base is free of mineral filler. The polyol may be any of the polyols set forth herein as suitable for inclusion in a chewing gum base. In one embodiment, the polyol is mannitol. In one embodiment, the elastomer comprises a ground elastomer, and the process further comprises grinding an elastomer, according to the process set forth herein, to form the ground elastomer. In one embodiment, the process further comprises dusting the chewing gum base with a polyol.

### Base Dusting

Removing mineral filler from gum bases increases the tack of most bases. It thus may be desirable to dust the gum bases to prevent base blocking during shipping or storage. Mineral fillers, in particular talc and calcium carbonate, have commonly been used to dust gum base pellets, base sheets, and/or slabs of base. It has now been discovered that polyols, such as mannitol, are effective alternatives to mineral fillers at dusting gum bases.

Thus, in another aspect, the present disclosure is directed to a process for producing a dusted chewing gum base. The process comprises dusting a chewing gum base with a polyol. In one embodiment, the chewing gum base is a chewing gum base of the present disclosure and is essentially free of mineral filler. In one particular embodiment, the chewing gum base is free of mineral filler. Suitable polyols include any of those discussed herein for inclusion in the gum base. In one particular embodiment, the gum base is dusted with mannitol. In one embodiment, the gum base is dusted with polyol in an amount of at least about 0.5% by weight of the chewing gum base, including from about 0.5% to about 10% by weight of the chewing gum base, from about 0.5% to about 4% by weight of the chewing gum base, or about 4% by weight of the chewing gum base. In one embodiment, the gum base is selected from the group consisting of a pellet, a sheet, a slab, and combinations thereof. Any suitable dusting means known in the art may be used for the methods described herein.

In another aspect, the present disclosure is directed to a chewing gum base that is essentially free of mineral filler, and that comprises a polyol, wherein the chewing gum base is dusted with a polyol.

### Preparation of Chewing Gum

The gum bases of the present disclosure can be included in chewing gum formulations. In general, chewing gum is manufactured by sequentially adding the various chewing gum ingredients to a commercially available mixer known in the art. After the initial ingredients have been thoroughly mixed, the gum mass is discharged from the mixer and shaped into the desired form such as by rolling into sheets and cutting into sticks, extruded into chunks or casting into pellets.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent/sweetener. Further portions of the bulking agent/sweetener may then be added to the mixer. A flavoring agent and/or other optional actives are typically added with the final portion of the bulking agent/sweetener. A high-intensity sweetener is preferably added after the final portion of bulking agent and flavor have been added.

The entire mixing procedure typically takes from five to fifteen minutes, longer mixing times may sometimes be required. Those skilled in the art will recognize that many variations of the above described procedure may be followed. One specifically contemplated embodiment is the use of an extruding mixer for continuous processing. In such a process, ingredients are added continuously at various points along the length of the extruder while homogeneously mixed gum continuously issues from the discharge end of the extruder. U.S. Pat. No. 6,017,565, herein incorporated by reference, discloses a continuous manufacture process which automatically and continuously feeds ingredients into an apparatus, mixes, and discharges the desired end product. The end product is automatically dusted, rolled scored and wrapped. U.S. Pat. No. 5,543,160 discloses a manufacturing process using high efficiency continuous mixing which does not require separate manufacture of gum base.

After mixing, the chewing gum is formed into a final product shape using well known techniques which may employ extrusion, rolling, sheeting, scoring or forming. The final product shape may be stick, tabs, chunks, pellets, balls or any other desired shape.

Pellet and ball forms, among others, are typically pan coated. Conventional panning procedures generally coat with sucrose, but recent advances in panning have allowed the use of other carbohydrate materials to be used in the place of sucrose. Some of these components include, but are not limited to, erythritol, sorbitol, dextrose, maltose, xylitol, hydrogenated isomaltulose and other new polyols or a combination thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetable gums like alginates, locust bean gum, guar gum and gum tragacanth, insoluble carbonates like calcium carbonate or magnesium carbonate, and talc. Erythritol also acts as a panning modifier with other panning materials to improve product quality. Anti-tack agents may also be added as panning modifiers, which allow the use of a variety of carbohydrates and sugar alcohols to be used in the development of new panned or coated gum products. Flavors may also be added with the erythritol sweetener to yield unique product characteristics.

If the chewing gum composition is in a pellet form, the initial coating syrup should have higher binder levels, e.g. gum Arabic or gum tallah, in the pre-coat, because conventional pre-coat does not stick to the pellet as it would on a conventional chewing gum composition. The increase of a binder allows for the appropriate adherence of the pre-coat. The present invention may be coated in amount ranging from about 30% to about 38%. Preferably, the coating is present at about 32% to about 36%.

### EXAMPLES

### Example 1: Rubber Grinding

In this example, the ability of mannitol to act as a dusting compound during grinding of butyl rubber was evaluated.

Test samples containing a blend of butyl rubber and dusting powder in a target amount of about 3 to about 10% by weight of the sample were prepared. The dusting powder used was either talc (control) or mannitol (experimental). The control and experimental samples each contained approximately the same amount of dusting powder. The samples were ground to approximately 6 mm pieces. Once grinding was complete, samples of the rubber blends were collected and placed in test cases. The samples were stressed for rubber blocking by placing weight onto the sample. The samples were checked for clumping after 24 and 48 hours.

### Results

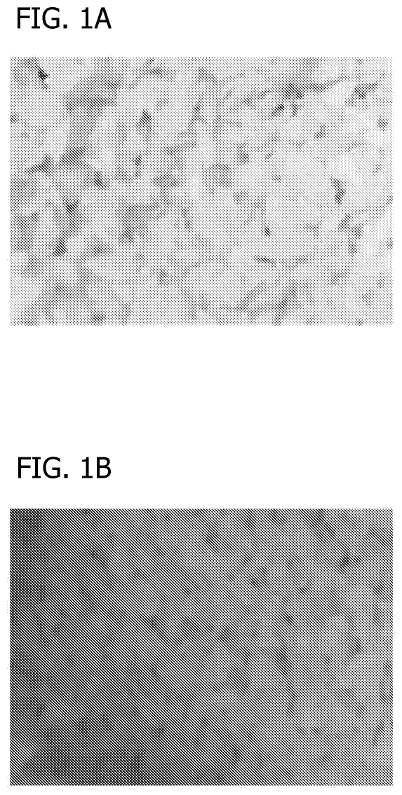

There were no observed issues during grinding for the control blend (containing talc). The control blend processed normally and had a good grind and dusting compound coverage. Similar to control, the experimental blend (containing mannitol, but no talc) also had good flow throughout discharge during grinding. At both 24 and 48 hours, the samples maintained good flow, and exhibited no clumping of the butyl rubber. The control and experimental blends after 48 hours of stress are shown in FIGS. 1A (control) and 1B (experimental). As can be seen from these figures, there was no observable clumping for either sample, and no observable difference between the control and experimental blends (note: the difference in color in FIG. 1B is due to lighting; there was no observable difference in color between the control and experimental samples).

### Example 2: Compounding

In this example, the effect of including mannitol in a gum base during compounding was evaluated.

Gum bases were prepared that contained rubber and either a mineral filler (control), no mineral filler and no polyol (experimental #1), or mannitol as a 1:1 replacement for the mineral filler (experimental #2). For experimental #1, no mineral filler or polyol were used during rubber grinding or compounding. For experimental #2, mannitol was added during rubber grinding, and also was compounded into the gum base formula. The gum base formulas for the control, experimental #1, and experimental #2 are set forth below.

| | Control | Exp #1 | Exp #2 |
|---|---|---|---|
| Talc | 17.190 | 0.000 | 0.000 |
| Mannitol | 0.000 | 0.000 | 17.190 |
| Butyl Rubber | 2.000 | 2.415 | 2.000 |
| SBR | 3.000 | 3.623 | 3.000 |
| PIB | 11.500 | 13.887 | 11.500 |
| PVAc | 26.000 | 31.397 | 26.000 |
| Estergum Rosin | 16.000 | 19.321 | 16.000 |
| Vegetable Oil | 17.500 | 21.133 | 17.500 |
| Plasticizer | 3.000 | 3.623 | 3.000 |
| Emulsifier | 3.750 | 4.528 | 3.750 |
| Antioxidant | 0.060 | 0.073 | 0.060 |
| | 100.000 | 100.000 | 100.000 |

The properties of the gum bases at various stages of compounding were observed. Results are reported in the table below.

### Results

| | | Filler | | Suitable |
|---|---|---|---|---|
| Base | Filler | Amount | | for use |
| Formula | type | (wt %) | Observations | in gum? |
| Control | Talc | 17.190 | Compounded ok upfront. | Yes |
| | | | Mixed well. | |
| Experimental | n/a | 0 | Compounded well initially, | Yes |
| #1 | | | then rolled around blades, | |
| | | | requiring manual | |
| | | | manipulation and some | |
| | | | modification to the mix | |
| | | | procedure. | |
| Experimental | n/a | 0 | Compounded ok upfront. | Yes |
| #2 | | | Mixed well. | |

The results demonstrate that mannitol can be used to aid in compounding of gum bases that contain no mineral filler.

### Example 3: Base Blocking and Dusting

In this example, the effectiveness of mannitol as a dusting compound for a gum base was evaluated.

A soft bubble gum base was dusted with either 2% talc (control) or 4% mannitol (experimental). Since removing all mineral filler from a base formula increases the tack of most bases, the experimental, mineral filler-free samples were prepared with a higher level of dusting powder (i.e., 4% mannitol). The dusted base samples were in slab form. The slabs were broken into small pieces prior to stress blocking testing.

An accelerated base stress blocking test was performed on the dusted bubble gum base samples as follows: 2.25 kilos of the dusted base sample was placed in a clear vessel. A 5 kg weight was placed on top of the sample, and the weighted sample was placed in an oven at a target of 85° F. (temperature fluctuated between 82-85° F.) for 72 hours.

### Results

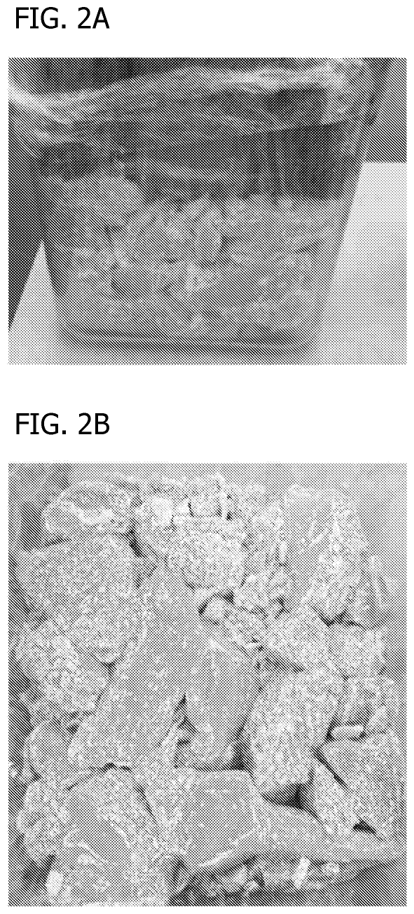

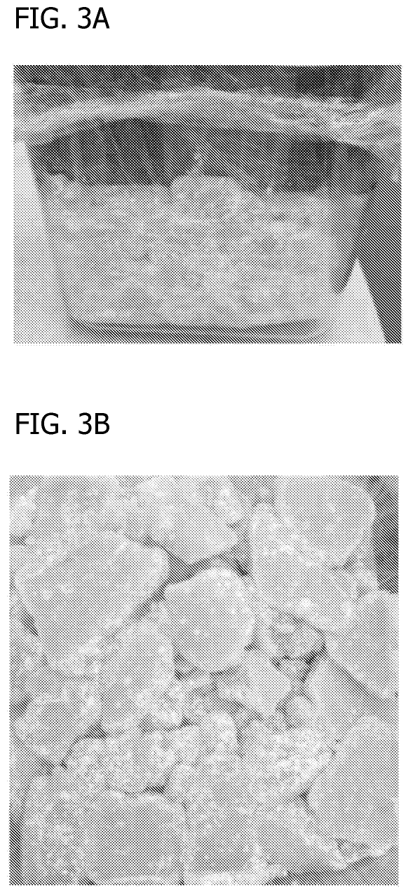

The results are shown in FIGS. 2A and 2B (control) and 3A and 3B (experimental). Observation of the samples following testing demonstrated that mannitol is a feasible alternative to talc for base dusting and performs at parity (at a 4%) level, as compared to the control (talc at a 2% level) for base dusting. Both sample bases compressed during testing but were easy to break apart.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A chewing gum base comprising a polyol, wherein the chewing gum base is essentially free of mineral filler.

2. The chewing gum base of claim 1, wherein the polyol is selected from the group consisting of mannitol, isomalt, erythritol, xylitol, maltitol, isomaltulose, sorbitol, allulose, and combinations thereof.

3. The chewing gum base of claim 1, wherein the polyol is mannitol.

4. The chewing gum base of claim 1, wherein the chewing gum base comprises the polyol in an amount of from about 0.5% to about 25% by weight of the chewing gum base.

5. The chewing gum base of claim 1, wherein the chewing gum base comprises mineral filler in an amount of less than 2% by weight of the chewing gum base.

6. The chewing gum base of claim 5, wherein the chewing gum base comprises mineral filler in an amount of less than 0.5% by weight of the chewing gum base.

7. The chewing gum base of claim 1, wherein the chewing gum base is free of mineral filler.

8. The chewing gum base of claim 1, wherein the mineral filler is selected from the group consisting of magnesium carbonate, calcium carbonate, ground limestone, magnesium silicate, aluminum silicate, clay alumina, talc, titanium dioxide, monocalcium phosphate, dicalcium phosphate, tricalcium phosphate, and calcium sulfate.

9. The chewing gum base of claim 1, wherein the chewing gum base further comprises an elastomer.

10. The chewing gum base of claim 1, wherein the chewing gum base is dusted with a polyol.

11-17. (canceled)

18. A process for preparing a chewing gum base, the process comprising mixing an elastomer and a polyol, wherein the chewing gum base is essentially free of mineral filler.

19. The process of claim 18, wherein the polyol is selected from the group consisting of mannitol, isomalt, erythritol, xylitol, maltitol, isomaltulose, sorbitol, allulose, and combinations thereof.

20. The process of claim 18, wherein the polyol is mannitol.

21. The process of claim 18, wherein the chewing gum base comprises mineral filler in an amount of less than 2% by weight of the chewing gum base.

22. The process of claim 21, wherein the chewing gum base comprises mineral filler in an amount of less than 0.5% by weight of the chewing gum base.

23. The process of claim 18, wherein the chewing gum base is free of mineral filler.

24. The process of claim 18, wherein the elastomer is selected from the group consisting of a ground elastomer, an unground elastomer, and combinations thereof.

25. The process of claim 18, wherein the elastomer comprises a ground elastomer, and the process further comprises combining an elastomer with a polyol to form an elastomer blend, and grinding the elastomer blend to form the ground elastomer, wherein the elastomer blend is essentially free of mineral filler.

26. The process of claim 18, further comprising dusting the chewing gum base with a polyol.

27. A process for producing a dusted chewing gum base, the process comprising dusting a chewing gum base with a polyol.

28. The process of claim 27, wherein the dusted chewing gum base comprises mineral filler in an amount of less than 2% by weight of the dusted chewing gum base.

29. The process of claim 28, wherein the dusted chewing gum base comprises mineral filler in an amount of less than 0.5% by weight of the dusted chewing gum base.

30. The process of claim 27, wherein the dusted chewing gum base is essentially free of mineral filler.

31. The process of claim 27, wherein the polyol comprises mannitol.

32. A chewing gum comprising the chewing gum base of claim 1.
